(19) United States
(12) Patent Application Publication
(10) Pub. No.: US 2025/0154751 A1
(43) Pub. Date: May 15, 2025

(54) ECO-FRIENDLY SHOWERHEAD

(71) Applicant: AS America, Inc., Piscataway, NJ (US)

(72) Inventors: Steven D. KAPPUS, Manville, NJ (US); Mahendra GUNAWARDENA, Hillsborough, NJ (US); Behnam HEYDARI, Ridgewood, NJ (US)

(73) Assignee: AS America, Inc., Piscataway, NJ (US)

(21) Appl. No.: 18/839,877

(22) PCT Filed: Feb. 27, 2023
(86) PCT No.: PCT/US2023/063364

§ 371 Date: Aug. 20, 2024

Related U.S. Application Data
(60) Provisional application No. 63/314,965, filed on Feb. 28, 2022.

(51) Int. Cl. E03C 1/04; B05B 12/00; B05B 12/12; E03C 1/02; E03C 1/05

(52) U.S. Cl. CPC E03C 1/0408; B05B 12/002; B05B 12/004; B05B 12/122; E03C 1/057; E03C 2001/026

(57) ABSTRACT

Provided are showerhead assemblies comprising a showerhead and a control panel. The showerhead includes a diverter configured to switch between each of a plurality of spray configurations and a temperature sensor configured to detect a temperature of fluid that flows through the conduit to the showerhead face. The control panel includes a control configured to receive a user input. The diverter is configured to, when a user causes the showerhead assembly to assume an open configuration, initially cause the fluid to flow from the showerhead at the standard spray configuration until the temperature sensor detects the fluid temperature to be in a range of the desired fluid temperature, and, if the fluid temperature is within about 3 degrees of the desired fluid temperature and no user presence is detected, the diverter is configured to switch to the low spray configuration.

### CROSS-REFERENCE TO RELATED APPLICATIONS

This application claims the benefit of U.S. Provisional Application No. 63/314,965, filed Feb. 28, 2022, the entire contents of which is incorporated herein by reference.

### FIELD

The present disclosure generally relates to showerheads. More specifically, this disclosure relates to showerheads that facilitate efficient water use.

### BACKGROUND

Conventional showerheads are designed to deliver a continuous spray of water from the moment a user turns the shower on until the user switches the shower off Environmental regulations imposed by governments often limit the average flow rate of water through showerheads in order to reduce water waste. Conventional showerheads allow users to customize their shower experience within the limits of the imposed environmental regulations. For instance, conventional showerheads typically allow users to adjust water flow properties such as water pressure and spray pattern to a certain extent.

### SUMMARY

As mentioned above, governments often impose regulations to limit the average water flow rate through showerheads in an effort to reduce water usage. While conventional showerheads do allow users some freedom to customize their shower experience, the freedom is impeded by the imposed regulations. Limits on the average flow rate can degrade a user's shower experience by increasing the time and effort required to rinse. Furthermore, since users typically prefer warmer showers over colder showers, users frequently allow water to run for several minutes prior to physically entering the shower in order to ensure that the water reaches a desired temperature. As such, many gallons of water may end up wasted each time a user showers regardless of any environmental regulations. There exists a need for a showerhead assembly which ensures efficient water usage while providing a pleasant and customizable shower experience to the user.

Accordingly, the present disclosure provides a showerhead assembly that automatically adjusts the water flow rate in order to maximize water conservation. In some embodiments, the showerhead assembly may comprise a presence sensor that is configured to detect the presence of a user in a shower stall or bath. If the user turns the shower on but does not enter the shower stall (for example, to allow the water to reach a desired temperature), the showerhead assembly may be configured to switch to a low flow setting, for example, once the desired temperature is achieved. In the low flow setting, the water flow rate may be reduced to a minimal flow rate in order to minimize water waste while maintaining the user's desired water temperature. By saving water in this manner, the showerhead assembly may reduce user guilt related to wasted water without requiring the user to change any aspect of their lifestyle.

In some embodiments, the presence sensor may be remote rather than embedded in the showerhead itself. The remote sensor can be placed on a wall below the showerhead. This may allow users to be detected when they are in the shower stall or bath but not standing directly beneath the showerhead. The remote sensor may also facilitate easy detection of users of varying heights.

In addition to the low flow setting, the showerhead assembly may provide an oscillatory setting wherein the water flow rate is caused to periodically fluctuate between a lower flow rate and a higher flow rate. Environmental regulations typically enforce a threshold for the average flow rate (as opposed to the maximum flow rate); thus, the higher flow rate may be greater than the threshold value, provided the average flow over a given time period remains at or below the threshold. The bursts of water flowing at a higher-than-average rate may increase user enjoyment of the shower while maintaining compliance with environmental regulations.

In some embodiments, a showerhead assembly is provided, the showerhead assembly comprising a showerhead comprising: a fluid inlet configured to fluidly connect to a fluid source and receive fluid from the fluid source; a face comprising a plurality of fluid outlets configured to dispense fluid out of the showerhead; a conduit configured to direct fluid from the fluid inlet to the face; a diverter positioned in the conduit and configured to control a flow of fluid through the conduit by switching between each of a plurality of spray configurations; and a temperature sensor positioned in the conduit and configured to detect a fluid temperature of fluid that flows through the conduit to the face, and a control system comprising: a presence sensor configured to detect a user presence; and a control panel comprising a control configured to receive a user input, wherein the plurality of spray configurations comprises a low spray configuration configured to cause fluid to exit the plurality of fluid outlets at a first flow rate and a standard spray configuration configured to cause fluid to exit the plurality of fluid outlets at a second flow rate, wherein the second flow rate is greater than the first flow rate, wherein, when a user causes the showerhead assembly to assume an open configuration, the diverter initially causes the fluid to flow from the showerhead at the standard spray configuration until the temperature sensor detects the fluid temperature to be in a range of the desired fluid temperature, and, if the temperature sensor detects the fluid temperature to be within about 3 degrees Fahrenheit of the desired fluid temperature and the presence sensor does not detect the user presence, the diverter is configured to switch to the low spray configuration.

In some embodiments of the showerhead assembly, the control panel comprises a user interface configured to receive one or more user inputs from the user during operation of the showerhead.

In some embodiments of the showerhead assembly, a first user input of the one or more user inputs is configured to cause the diverter to switch between a first spray configurations of the plurality of spray configurations to a second spray configuration of the plurality of spray configurations.

In some embodiments of the showerhead assembly, the control panel is configured to be placed on a shower wall.

In some embodiments of the showerhead assembly, the control panel comprises a user interface comprising one or more buttons, each button of the one or more buttons corresponding to a spray configuration of the plurality of spray configurations.

In some embodiments of the showerhead assembly, the second flow rate is between about 1.5 and 3.5 gallons per minute.

In some embodiments of the showerhead assembly, the first flow rate is less than about 1 gallon per minute.

In some embodiments of the showerhead assembly, the plurality of spray configurations comprise an oscillating spray configuration configured to cause a flow rate of the fluid exiting the plurality of fluid outlets to oscillate between a third flow rate and a fourth flow rate while maintaining an average flow rate equal to the second flow rate.

In some embodiments of the showerhead assembly, the third flow rate is between about 1 and 2.5 gallons per minute.

In some embodiments of the showerhead assembly, the fourth flow rate is between about 3 and 5 gallons per minute.

In some embodiments of the showerhead assembly, the presence sensor is configured to detect the user presence when the user is within about 5 feet of the presence sensor.

In some embodiments of the showerhead assembly, the presence sensor is configured to detect infrared radiation.

In some embodiments of the showerhead assembly, the presence sensor is a motion sensor.

In some embodiments of the showerhead assembly, the presence sensor is configured to attach to the control panel.

In some embodiments of the showerhead assembly, the presence sensor is configured to attach to the showerhead.

In some embodiments, a showerhead assembly is provided, the showerhead assembly comprising a showerhead comprising: a fluid inlet configured to fluidly connect to a fluid source and receive fluid from the fluid source; a face comprising a plurality of fluid outlets configured to dispense fluid out of the showerhead; a conduit configured to direct fluid from the fluid inlet to the face; a diverter positioned in the conduit and configured to control a flow of fluid through the conduit by switching between each of a plurality of spray configurations; and a temperature sensor positioned in the conduit and configured to detect a fluid temperature of fluid that flows through the conduit to the face, and a control system comprising: a control panel comprising a control configured to receive a user input, wherein the plurality of spray configurations comprises: an oscillating spray configuration configured to cause a flow rate of the fluid exiting the plurality of fluid outlets to oscillate between a fifth flow rate and a sixth flow rate while maintaining an average flow rate equal to a seventh flow rate, wherein the sixth flow rate is greater than the fifth flow rate; wherein, when a user causes the showerhead assembly to assume an open configuration, the diverter initially causes the fluid to flow from the showerhead at the seventh flow rate until the temperature sensor detects the fluid temperature to be in a range of the desired fluid temperature, and, if the temperature sensor detects the fluid temperature to be within about 3 degrees of the desired fluid temperature and the control receives the user input, the diverter is configured to switch to the oscillating spray configuration.

In some embodiments of the showerhead assembly, the control panel comprises a user interface configured to receive one or more user inputs from the user during operation of the showerhead.

In some embodiments of the showerhead assembly, a first user input of the one or more user inputs is configured to cause the diverter to switch between a first spray configurations of the plurality of spray configurations to a second spray configuration of the plurality of spray configurations.

In some embodiments of the showerhead assembly, the control panel is configured to be placed on a shower wall.

In some embodiments of the showerhead assembly, the control panel comprises a user interface comprising one or more buttons, each button of the one or more buttons corresponding to a spray configuration of the plurality of spray configurations.

In some embodiments of the showerhead assembly, seventh flow rate is between about 1.5 and 3.5 gallons per minute.

In some embodiments of the showerhead assembly, the fifth flow rate is between about 1 gallon and 2.5 gallons per minute.

In some embodiments of the showerhead assembly, the sixth flow rate is between about 3 and 5 gallons per minute.

In some embodiments of the showerhead assembly, the control system further comprises a presence sensor configured to detect a user presence.

In some embodiments of the showerhead assembly, the presence sensor is configured to detect the user presence when the user is within about 5 feet of the presence sensor.

In some embodiments of the showerhead assembly, the presence sensor is configured to detect infrared radiation.

In some embodiments of the showerhead assembly, the presence sensor is a motion sensor.

In some embodiments of the showerhead assembly, the presence sensor is configured to attach to the control panel.

In some embodiments of the showerhead assembly, the presence sensor is configured to attach to the showerhead.

In some embodiments of the showerhead assembly, the plurality of spray configurations further comprise a low spray configuration configured to cause fluid to exit the plurality of fluid outlets at an eighth flow rate, wherein the eighth flow rate is less than the seventh flow rate; wherein, when the showerhead assembly is in the open position and the presence sensor does not detect the user presence, the diverter is configured to cause the fluid to flow in the low spray configuration.

In some embodiments of the showerhead assembly, the eighth flow rate is less than about 1 gallon per minute.

### BRIEF DESCRIPTION OF THE FIGURES

The invention will now be described, by way of example only, with reference to the accompanying drawings.

FIG. 1 illustrates a showerhead assembly, according to some embodiments;

FIG. 2 illustrates another showerhead assembly, according to some embodiments;

FIG. 3 illustrates another showerhead assembly, according to some embodiments;

FIG. 4 illustrates a showerhead configured to sense water temperature and detect user motion, according to some embodiments; and

FIG. 5 shows flow rate data for a showerhead, according to some embodiments.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

### DETAILED DESCRIPTION

As discussed above, there exists a need for a showerhead assembly which ensures efficient water usage while providing a pleasant and customizable shower experience to the user. While conventional showerheads can allow users some freedom to customize their shower experience, the freedom is impeded by flow rate regulations imposed by governments in order to conserve water. Limits on the average flow rate can degrade a user's shower experience. The present disclosure provides a showerhead assembly that automatically adjusts the water flow rate in response to a shower user's presence and shower preferences in order to maximize both water conservation and user enjoyment.

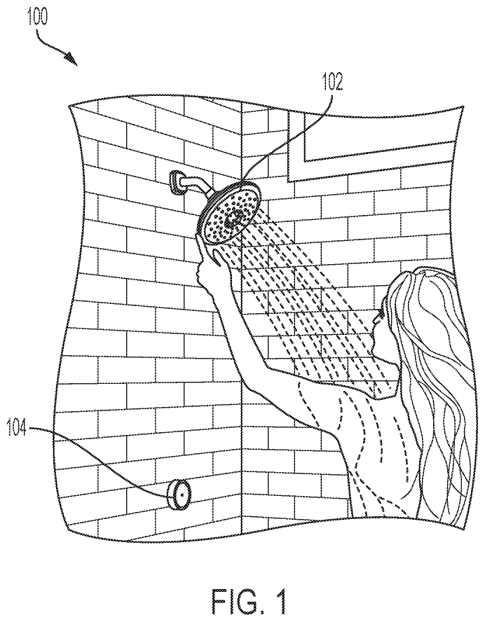

FIG. 1 illustrates a showerhead assembly according to some embodiments of the present disclosure. Specifically, FIG. 1 shows a showerhead assembly 100 comprising a showerhead 102 and a remote control panel 104. Showerhead 102 may be configured to receive water from a water supply and then dispense the water through a plurality of water outlets on a face of the showerhead into a shower stall or bath. In some embodiments, showerhead 102 may be configured to connect to an existing showerhead arm (e.g., the fluid conduit extending from the shower wall configured to connect the showerhead to the water supply).

In some embodiments, showerhead 102 and/or remote control 104 may include electronic components. Showerhead 102 and/or remote control 104 may be configured to receive energy from an energy source such as a battery in order to power any electrical components.

Showerhead assembly 100 may be configured to provide a plurality of spray configurations. One or more of the plurality of spray configurations may provide different water flow rates through showerhead 102. One or more of the plurality of spray configurations may provide different water spray patterns as the water exits showerhead 102. For example, spray configurations which cause water to be transmitted through all of the water outlets of showerhead 102 or only through a select group of water outlets of showerhead 102 may be provided by showerhead assembly 100. In some embodiments, a shower user may select one or more spray configurations based on preference. In some embodiments, showerhead assembly 100 may be configured to automatically engage certain spray configurations based on one or more shower conditions (e.g., water temperature or user presence in the vicinity of showerhead 102).

Remote control panel 104 may be configured to receive information related to one or more shower conditions. In some embodiments, the information may include information related to the presence of the shower user in the vicinity of showerhead 102 or information related to one or more spray configurations that have been chosen by the shower user. Remote control panel 104 may be configured to wirelessly communicate with showerhead 102 in order to control showerhead 102. Controlling showerhead 102 may comprise causing water to exit showerhead 102 in a certain spray configuration. In some embodiments, remote control panel 104 may include a user interface configured to receive user inputs that cause showerhead assembly 100 to switch to a chosen spray configuration.

As shown in FIG. 1, remote control panel 104 may be untethered from showerhead 102. In some embodiments, remote control panel 104 may be configured to be placed on a shower wall below showerhead 102. In some embodiments, remote control panel 104 may be fixed to a shower wall using an adhesive or using one or more suction cups. In some embodiments, the shower user may choose where to place remote control 104 based on their height and/or the heights of others who may use showerhead assembly 100.

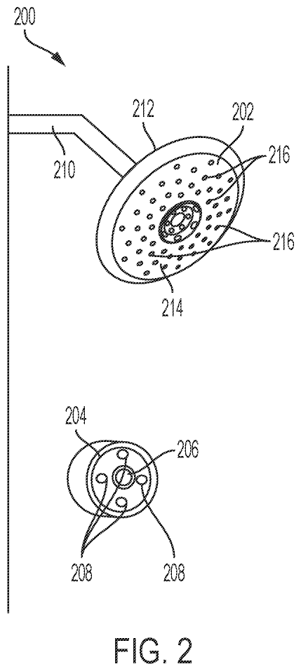

FIG. 2 illustrates another showerhead assembly according to some embodiments of the present disclosure. Specifically, FIG. 2 shows a showerhead assembly 200 comprising a showerhead 202 and a remote control 204. Remote control 204 may comprise a presence sensor 206 and a plurality of spray configuration controls 208. In some embodiments, showerhead assembly 200 may include features of showerhead assembly 100 as shown in FIG. 1. For example, showerhead 202 may include features of showerhead 102 or remote control 204 may include features of remote control 104.

Showerhead 202 may be configured to connect to a showerhead arm 210. Showerhead arm 210 may be configured to connect to a back face 212 of showerhead 202. When showerhead assembly 200 is turned on or to an open configuration, water may flow from a water supply and into a flow path housed by showerhead arm 210. Showerhead 202 may be configured to receive water from showerhead arm 210 at a water inlet located at the point of connection between showerhead arm 210 and back face 212. After showerhead 202 receives water from showerhead arm 210, the water may travel through a water conduit internal to showerhead 202 and then exit showerhead 202 through a plurality of water outlets 216 on face 214.

In some embodiments, presence sensor 206 may be configured to detect the presence of a user. Presence sensor 206 may be a passive presence sensor or an active presence sensor. In some embodiments, presence sensor 206 may be an infrared sensor configured to detect infrared radiation that is emitted by the shower user's body. In some embodiments, presence sensor 206 may be a microwave sensor configured to emit microwave radiation and detect a reflection of said radiation off of the shower user's body. In some embodiments, presence sensor 206 may be an ultrasonic sensor configured to emit ultrasonic waves and detect a reflection of said waves off of the shower user's body. In some embodiments, presence sensor 206 may be a motion sensor configured to detect changes in lighting that occur due to movement of the shower user.

Presence sensor 206 may be triggered when the shower user comes within a preset range of remote control 204. When presence sensor 206 is triggered, remote control 204 may be configured to transmit a signal to showerhead 202 comprising information related to the shower user's presence. In some embodiments, presence sensor 206 may be triggered when the distance between remote control 204 and the shower user is less than or equal to 10 feet, 8 feet, 5 feet, 4 feet, 3 feet, 2 feet, or 1 foot. In some embodiments, presence sensor 206 may be triggered when the distance between remote control 204 and the shower user is 0-1 foot, 0-2 feet, 0-3 feet, 0-4 feet, 0-5 feet, or 0-10 feet. In some embodiments, presence sensor 206 may be configured to detect the shower user's presence only when the shower user stands directly in front of presence sensor 206. This may prevent presence sensor 206 from detecting a presence that is outside of the shower stall or bath.

Like showerhead assembly 100 shown in FIG. 1, showerhead assembly 200 may be configured to provide a plurality of spray configurations. In some embodiments, one or more spray configurations may be initiated using spray configuration controls 208. In some embodiments, spray configuration controls 208 may comprise one or more push buttons, one or more switches, one or more pressure sensors, or one or more capacitive touch sensors. While showering, a user may select a desired spray configuration using one or more spray configuration controls 208. Remote control 204 may receive one or more signals from the one or more spray configuration controls 208 comprising information related to the selected spray configuration. Based on the received information, remote control 204 may be configured to transmit one or more signals to showerhead 202. Showerhead 202 may then be configured to adjust a water flow rate or a spray pattern of water transmitted through water outlets 216 in response to the one or more signals received from remote control 204.

In some embodiments, showerhead assembly 200 may provide a low flow spray configuration that causes water to exit water outlets 216 at a minimal flow rate. The low flow configuration may be a “trickle” mode wherein, for a given period of time, a relatively small volume of water is transmitted from showerhead 202 into the shower stall or tub. In some embodiments, the minimal flow rate may be less than or equal to about 1.5 gpm, about 1 gpm, about 0.75 gpm, about 0.5 gpm, or about 0.25 gpm. In some embodiments, the minimal flow rate may be greater than or equal to about 0.1 gpm, about 0.2 gpm, about 0.3 gpm, about 0.4 gpm, about 0.5 gpm, or about 1 gpm. In some embodiments, the minimal flow rate may be about 0.1-0.25 gpm, about 0.25-0.5 gpm, about 0.5-0.75 gpm, or about 0.75-1 gpm.

In some embodiments, the low flow configuration may be automatically triggered if the shower user has started the shower but steps out of the range of presence sensor 206 (e.g., if the shower user exits the shower stall or bath) or has not yet stepped into the range of presence sensor 206 (e.g., if the shower user starts the shower but does not enter the stall). By reducing the flow rate when the shower is on but the shower user is not actively showering, showerhead assembly 200 prevents an excess amount of water from being wasted. In some embodiments, the low flow configuration may be automatically triggered if the shower user has started the shower but presence sensor 206 has not detected the presence of the shower user for a certain amount of time. In some embodiments, the low flow configuration may be automatically triggered if the shower user has started the shower but presence sensor 206 has not detected the presence of the shower user for at least about 1 second, at least about 5 seconds, at least about 10 seconds, at least about 15 seconds, or at least about 30 seconds. In some embodiments, the low flow configuration may be triggered once the water temperature of the water passing through the plurality of openings 216 reaches a set temperature.

In some embodiments, showerhead assembly 202 may be configured to restrict the average flow rate of water exiting water outlets 216 in order to comply with environmental regulations or building codes. Showerhead assembly 202 may restrict the average flow rate by ensuring that the average flow rate (in any spray configuration) does not exceed a predetermined flow rate threshold. In some embodiments, the flow rate threshold may be less than or equal to about 3 gpm, about 2.5 gpm, about 2 gpm, or about 1.5 gpm. In some embodiments, the flow rate threshold may be greater than or equal to about 0.5 gpm, about 1 gpm, about 1.5 gpm, or about 2 gpm. In some embodiments, the flow rate threshold may be about 1.5-1.8 gpm, about 1.8-2.0 gpm, about 2.0-2.2 gpm, or about 2.2-2.5 gpm.

In some embodiments, showerhead assembly 200 may be configured to provide one or more standard spray configurations that cause water to exit water outlets 216 at a standard flow rate that is greater than the minimal flow rate of the low flow configuration but less than or equal to the flow rate threshold. In some embodiments, the standard flow rate may be less than or equal to about 3 gpm, about 2.5 gpm, about 2 gpm, or about 2.5 gpm. In some embodiments, the standard flow rate may be greater than or equal to about 0.1 gpm, about 0.2 gpm, about 0.3 gpm, about 0.4 gpm, about 0.5 gpm, or about 1 gpm. In some embodiments, the standard flow rate may be about 1.5-1.8 gpm, about 1.8-2.0 gpm, about 2.0-2.2 gpm, or about 2.2-2.5 gpm. In some embodiments, switching between one or more standard spray configurations may cause water to exit water outlets 216 in a different spray pattern (e.g., may cause water to exit different portions of water outlets 216).

In some embodiments, showerhead assembly 200 may provide an oscillatory flow spray configuration that causes the flow rate of water exiting water outlets 216 to fluctuate between a lower flow rate and a higher flow rate. The higher flow rate may be significantly greater than the flow rate threshold as long as the average flow rate remains at or below the predetermined flow rate threshold. This may allow users to experience water flow rates higher than the standard flow rates (which may facilitate easier rinsing and make the user's shower experience more enjoyable) while simultaneously ensuring that showerhead assembly 200 complies with any necessary regulations. For example, if the flow rate threshold is 3 gpm, the higher flow rate may be as great as 5 gpm provided the lower flow rate is less than 1 gpm. In some embodiments, the higher flow rate may be greater than or equal to about 1.5 gpm, about 2 gpm, about 2.5 gpm, about 3 gpm, about 3.5 gpm, about 4 gpm, or about 4.5 gpm. In some embodiments, the higher flow rate may be less than or equal to about 10 gpm, about 8 gpm, about 6 gpm, about 5.5 gpm, or about 5 gpm. In some embodiments, the higher flow rate may be about 2.5-3 gpm, about 3-3.5 gpm, about 3.5-4 gpm, about 4-4.5 gpm, or about 4.5-5 gpm. In some embodiments, the lower flow rate may be greater than or equal to about 0.1 gpm, about 0.2 gpm, about 0.3 gpm, about 0.4 gpm, about 0.5 gpm, or about 1 gpm. In some embodiments, the lower flow rate may be less than or equal to about 1.5 gpm, about 2 gpm, about 2.5 gpm, about 3 gpm, about 3.5 gpm, about 4 gpm, or about 4.5 gpm. In some embodiments, the lower flow rate may be about 0.5-1 gpm, about 1-1.5 gpm, about 1.5-2 gpm, or about 2-2.5 gpm. In some embodiments, the shower user may trigger the oscillatory flow spray configuration using one or more spray configuration controls 208 on remote control 204.

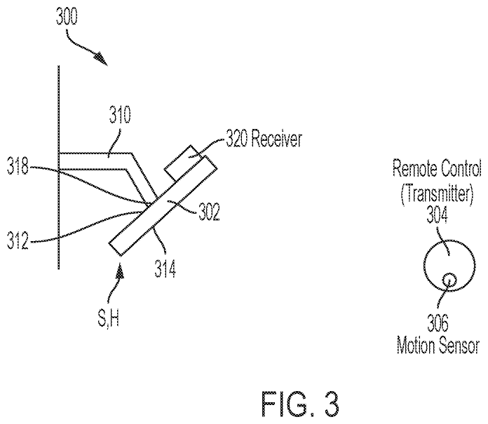

FIG. 3 illustrates showerhead assembly 300 according to some embodiments of the present disclosure. In particular, FIG. 3 shows a showerhead assembly 300 comprising a showerhead 302 and a remote control 304. In some embodiments, showerhead assembly 300 may comprise features of showerhead assembly 200 as shown in FIG. 2 and/or showerhead assembly 100 as shown in FIG. 1. For instance, showerhead 302 may include features of showerhead 202 or of showerhead 102; likewise, remote control 304 may include features of remote control 204 or of remote control 104.

As shown, showerhead 302 may be configured to connect to a shower arm 310. Shower arm 310 may connect to a water inlet 318 on a back face 312 of showerhead 302. When a shower user turns shower assembly 300 on, shower arm 310 may transmit water received from a water supply through water inlet 318 and into showerhead 302. After the water passes through water inlet 318, it may travel through an internal water conduit housed within showerhead 302 before being transmitted through one or more water outlets in a spray face 314. Showerhead assembly may be configured to provide a plurality of spray configurations, including the low spray configuration, one or more standard spray configurations, and the oscillatory spray configuration described above with respect to FIG. 2.

Remote control 304 may comprise a presence sensor 306 configured to detect the shower user's presence within the shower stall or bath. Presence sensor 306 may include features of or otherwise be similar to presence sensor 206 of shower assembly 200. In some embodiments, remote control 304 may be a transmitter configured to transmit information received from presence sensor 306 to showerhead 302. In some embodiments, remote control 304 may be configured to transmit information using infrared radiation, radio frequency radiation, or a Bluetooth signal.

In some embodiments, showerhead 302 may include a receiver 320 configured to receive information from remote control 304. Receiver 320 may be configured to receive infrared signals, radio frequency signal, or Bluetooth signals. Based on the information received by receiver 320, showerhead 302 may automatically initiate or change one or more spray configurations. For example, if showerhead assembly 300 is in a standard spray configuration and presence sensor 306 stops detecting the shower user's presence, remote control 304 may be configured to transmit a signal to receiver 320 indicating that the user has exited the shower stall. In response, showerhead 302 may switch from the standard spray configuration to the low spray configuration. Showerhead 302 may remain in the low spray configuration until receiver 320 receives a signal from remote control 304 indicating that the user has returned to the shower stall.

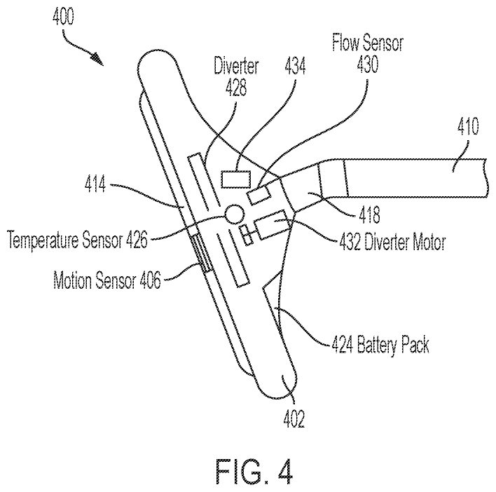

FIG. 4 illustrates a showerhead 400 configured to sense water temperature and detect user motion according to some embodiments of the present disclosure. Specifically, FIG. 4 shows a showerhead 400 attached to a showerhead arm 410. Showerhead arm 410 may connect to a water inlet 418. In turn, water inlet 418 may be in fluid communication with an internal cavity or conduit 422 of showerhead 400. Water inlet 418 may receive water from showerhead arm 410 and then transmit the water to internal cavity or conduit 422. After water has traveled through internal cavity or conduit 422, it may exit showerhead 400 via one or more water outlets on a spray face 414.

In some embodiments, internal cavity or conduit 422 may house a plurality of sensors configured to detect one or more shower conditions. As shown, internal cavity or conduit 422 houses a temperature sensor 426 and a flow sensor 430. Temperature sensor 426 may be configured to measure the temperature of the water entering internal cavity or conduit 422 from water inlet 418. Flow sensor 430 may be configured to measure the flow rate of water as it enters internal cavity or conduit 422.

In some embodiments, showerhead 400 may house a diverter 428 configured to control the flow of water through internal cavity or conduit 422 in order to switch between a plurality of spray configurations. The plurality of spray configurations may include the low spray configuration, one or more standard spray configurations, and the oscillatory spray configuration described above with respect to FIG. 2. Movements of diverter 428 may be controlled by a diverter motor 432. Diverter motor 432 may in turn be controlled by a microcontroller 434.

In some embodiments, showerhead 400 may include a power source 424 configured to provide energy to one or more components of showerhead 400. In some embodiments, power source 424 may comprise one or more batteries. In some embodiments, power source 424 may be removable (e.g., so that the shower user may exchange old batteries for new batteries). In some embodiments, power source 424 may be rechargeable.

In some embodiments, showerhead 400 may include a presence sensor or receiver 406. Presence sensor or receiver 406 may be disposed on spray face 414. In some embodiments, presence sensor or receiver 406 may be a presence sensor that includes features of presence sensor 306 of showerhead assembly 300, presence sensor 206 of showerhead assembly 200, and/or presence sensor 106 of showerhead assembly 100. In some embodiments, presence sensor or receiver 406 may be configured to receive user presence information transmitted by a separate remote control system which includes a presence sensor.

In some embodiments, showerhead 400 may be configured to receive one or more user inputs indicating one or more desired shower conditions and/or spray configurations. If a user input indicates that the user wishes to switch from a current spray configuration to a new spray configuration, microcontroller 434 may be configured to cause diverter motor 432 to move diverter 428 in order to appropriately adjust the water flow from the current spray configuration to the new spray configuration. Flow sensor 430 may be configured to communicate flow rate information to microcontroller 434 in order to ensure that the appropriate flow rate conditions for a given spray configuration are being achieved.

In some embodiments, the shower user may provide a desired water temperature. The water temperature may be provided when the shower user turns the shower on. For instance, the user may select a desired shower temperature by rotating a knob of a water supply valve. In some embodiments, a user may set a desired shower water temperature by providing a user input onto a user interface of a remote control panel. Temperature sensor 426 may be configured to receive information related to the user's desired water temperature. Once water has begun to flow through internal cavity or conduit 422, temperature sensor 426 may be configured to detect a current water temperature and to compute a difference between the current water temperature and the user's desired water temperature. In some embodiments, temperature sensor 426 may be configured to communicate temperature information with diverter 428 and to indicate when temperature sensor 426 detects that the current water temperature is within an acceptable range of the user's desired water temperature. In some embodiments, the current water temperature may be considered to be within an acceptable range of the user's desired water temperature if the difference between the current water temperature and the user's desired water temperature is less than or equal to about 10° F., about 5° F., about 3° F., about 2° F., about 1° F., about 0.5° F., or about 0.1° F. In some embodiments, if the difference between the current water temperature and the user's desired water temperature is large, diverter 428 may be configured to cause the flow rate of water exiting spray face 414 to temporarily increase in order to purge lower temperature water from showerhead 400.

In some embodiments, showerhead 400 may be configured to automatically enter a certain spray configuration based on information received by presence sensor or receiver 406 and/or one or more user inputs. In some embodiments, the shower user may turn the shower on, causing water to be received by showerhead 400 at water inlet 418 and exit showerhead 400 via one or more water outlets in spray face 414. In some embodiments, when the shower user starts the shower, showerhead 400 may automatically enter a standard spray configuration that causes water to exit showerhead 400 at a standard flow rate. In some embodiments, while turning the shower on, the shower user may select a desired water temperature. In order to allow the water sufficient time to reach the desired temperature, the user may then step away from showerhead 400. Presence sensor or receiver 406 may detect that the user has stepped away from showerhead 400 or may receive a signal indicating that the user has stepped away from showerhead 400. In some embodiments, temperature sensor 426 may indicate that the current water temperature is within an acceptable range of the user's desired water temperature before presence sensor or receiver 406 has indicated that the user has returned to showerhead 400. In such a case, microcontroller 434 may automatically control diverter 428 to cause showerhead 400 to enter a low flow configuration wherein water is caused to exit showerhead 400 at a minimal flow rate. In some embodiments, if showerhead 400 has been caused to enter the low flow configuration and then presence sensor or receiver 406 indicates that the shower user has returned, microcontroller 434 may automatically control diverter 428 to cause showerhead 400 to return to the previously occupied standard spray configuration. In some embodiments, the fluid/water temperature as measured my temperature sensor 426 may be considered to be within an acceptable range of the selected water/fluid temperature when the measured temperature is within about 5, about 4, about 3, about 2, or about 1 degree F.

In some embodiments, in order to cause the temperature of the shower water to heat up at a faster rate, the shower user may start the shower on its highest temperature setting. The user may then step away from showerhead 400 in order to allow the water sufficient time to heat up. In some embodiments, presence sensor or receiver may detect that the user has stepped away from showerhead 400. Temperature sensor 426 may track the temperature of the water. In some embodiments, when the water has reached the maximum temperature, microcontroller 434 may automatically control diverter 428 to cause showerhead 400 to enter a low flow configuration wherein water is caused to exit showerhead 400 at a minimal flow rate. In some embodiments, after showerhead 400 has been caused to enter a low flow configuration, showerhead 400 may be configured to automatically reduce the water temperature to a desired water temperature that has been pre-set. In some embodiments, the desired water temperature may be pre-set by the user. Reducing the temperature of the water from the maximum temperature ensures that the shower user will not step into a shower emitting scalding water. In some embodiments, if showerhead 400 has been caused to enter the low flow configuration and then presence sensor or receiver 406 indicates that the shower user has returned, microcontroller 434 may automatically control diverter 428 to cause showerhead 400 to return to the previously occupied standard spray configuration.

In some embodiments, a system comprising one or more of presence sensor or receiver 406, power source 424, temperature sensor 426, diverter 428, flow sensor 430, diverter motor 432, and microcontroller 434 may be configured to connect to an existing showerhead in order to allow the existing showerhead to operate as described above. In some embodiments, retrofitting such a system onto an existing showerhead may allow automatic adjustment of one or more spray configurations based on user presence information collected by presence sensor or receiver 406. For example, a retrofit system can include a device configured to couple to a shower arm between the shower arm and the showerhead. The device can include a temperature sensor, diverter, etc. The retrofit system can also include a control panel as described herein, configured to receive a user input.

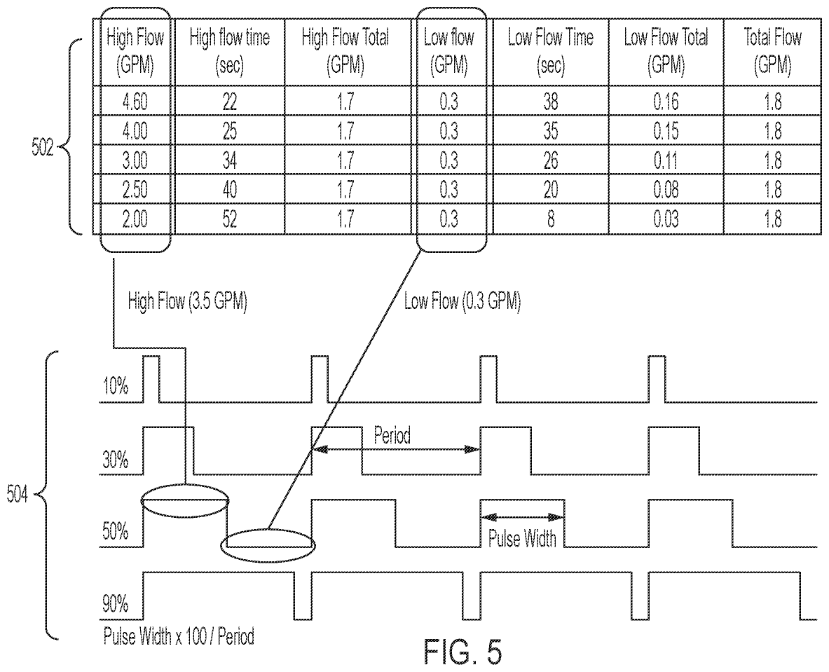

FIG. 5 shows flow rate data for a showerhead according to some embodiments of the present disclosure. Specifically, FIG. 5 shows a data table 502 and a series of plots 504 providing exemplary flow rates over time for water passing through a showerhead assembly that is in an oscillatory spray configuration. As previously discussed, a showerhead assembly according to the present disclosure may be configured to restrict the average flow rate of water exiting the showerhead in order to comply with environmental regulations or building codes. The showerhead assembly may restrict the average flow rate by ensuring that the average flow rate (in any spray configuration) does not exceed a predetermined flow rate threshold. However, in order to ensure that shower users have an enjoyable shower experience in spite of potentially restrictive flow rate thresholds, shower assemblies according to the present disclosure may be configured to provide an oscillatory flow spray configuration that causes the flow rate of water exiting showerheads to periodically fluctuate between a lower flow rate and a higher flow rate. The higher flow rate may be significantly greater than the flow rate threshold as long as the average flow rate remains at or below the predetermined flow rate threshold.

As shown in plots 504, the oscillatory spray configuration may cause water to be delivered to the shower user at a higher flow rate for a first period of time and at a lower flow rate for a second period of time. The length of the first period of time and the second period of time may be based on the higher flow rate, the lower flow rate, and the flow rate threshold. In some embodiments, the first period of time may equal the second period of time. In some embodiments, the first period of time may be greater than the second period of time. In some embodiments, the first period of time may be less than the second period of time. The first period of time and the second period of time may be measured with as portions of an overall period (for example, 1 minute) over which the average flow rate is measured. For example, table 502 shows data indicating an oscillatory spray configuration in which water is delivered from a showerhead at 4.60 gpm (higher flow rate) for 22 seconds (first time period) and then at 0.3 gpm (lower flow rate) for 38 seconds (second time period). A showerhead delivering water at a rate of 4.60 gpm for 22 seconds delivers a 1.7 total gallons of water. A showerhead delivering water at a rate of 0.3 gpm for 38 seconds delivers 0.16 total gallons of water. Thus, the total amount of water delivered in 60 seconds by the showerhead is 1.8 gpm. As shown in table 502, there may exist a variety of combinations of higher flow rates, lower flow rates, first periods of time, and second periods of time that result in the same total amount of water being delivered in a single minute.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

In addition, it is also to be understood that the singular forms “a”, “an”, and “the” used in the following description are intended to include the plural forms as well, unless the context clearly indicates otherwise. It is also to be understood that the term “and/or” as used herein, refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A showerhead assembly comprising:
a showerhead comprising:
a fluid inlet configured to fluidly connect to a fluid source and receive fluid from the fluid source;
a face comprising a plurality of fluid outlets configured to dispense fluid out of the showerhead;
a conduit configured to direct fluid from the fluid inlet to the face;
a diverter positioned in the conduit and configured to control a flow of fluid through the conduit by switching between each of a plurality of spray configurations; and
a temperature sensor positioned in the conduit and configured to detect a fluid temperature of fluid that flows through the conduit to the face, and
a control system comprising:
a presence sensor configured to detect a user presence; and
a control panel comprising a control configured to receive a user input,
wherein the plurality of spray configurations comprises a low spray configuration configured to cause fluid to exit the plurality of fluid outlets at a first flow rate and a standard spray configuration configured to cause fluid to exit the plurality of fluid outlets at a second flow rate, wherein the second flow rate is greater than the first flow rate,
wherein, when a user causes the showerhead assembly to assume an open configuration, the diverter initially causes the fluid to flow from the showerhead at the standard spray configuration until the temperature sensor detects the fluid temperature to be in a range of the desired fluid temperature, and, if the temperature sensor detects the fluid temperature to be within about 3 degrees Fahrenheit of the desired fluid temperature and the presence sensor does not detect the user presence, the diverter is configured to switch to the low spray configuration.

2. The showerhead assembly of claim 1, wherein the control panel comprises a user interface configured to receive one or more user inputs from the user during operation of the showerhead.

3. The showerhead assembly of claim 2, wherein a first user input of the one or more user inputs is configured to cause the diverter to switch between a first spray configuration of the plurality of spray configurations to a second spray configuration of the plurality of spray configurations.

4. The showerhead assembly of claim 1, wherein the control panel comprises a user interface comprising one or more buttons, each button of the one or more buttons corresponding to a spray configuration of the plurality of spray configurations.

5. The showerhead assembly of claim 1, wherein the second flow rate is between about 1.5 and 3.5 gallons per minute.

6. The showerhead assembly of claim 1, wherein the first flow rate is less than about 1 gallon per minute.

7. The showerhead assembly of claim 1, wherein the plurality of spray configurations comprise an oscillating spray configuration configured to cause a flow rate of the fluid exiting the plurality of fluid outlets to oscillate between a third flow rate and a fourth flow rate while maintaining an average flow rate equal to the second flow rate.

8. The showerhead assembly of claim 7, wherein the third flow rate is between about 1 and 2.5 gallons per minute.

9. The showerhead assembly of claim 8, wherein the fourth flow rate is between about 3 and 5 gallons per minute.

10. The showerhead assembly of claim 1, wherein the presence sensor is configured to attach to the control panel.

11. The showerhead assembly of claim 1, wherein the presence sensor is configured to attach to the showerhead.

12. A showerhead assembly comprising:
a showerhead comprising:
a fluid inlet configured to fluidly connect to a fluid source and receive fluid from the fluid source;
a face comprising a plurality of fluid outlets configured to dispense fluid out of the showerhead;
a conduit configured to direct fluid from the fluid inlet to the face;
a diverter positioned in the conduit and configured to control a flow of fluid through the conduit by switching between each of a plurality of spray configurations; and
a temperature sensor positioned in the conduit and configured to detect a fluid temperature of fluid that flows through the conduit to the face, and
a control system comprising:
a control panel comprising a control configured to receive a user input,
wherein the plurality of spray configurations comprises:
an oscillating spray configuration configured to cause a flow rate of the fluid exiting the plurality of fluid outlets to oscillate between a fifth flow rate and a sixth flow rate while maintaining an average flow rate equal to a seventh flow rate, wherein the sixth flow rate is greater than the fifth flow rate;
wherein, when a user causes the showerhead assembly to assume an open configuration, the diverter initially causes the fluid to flow from the showerhead at the seventh flow rate until the temperature sensor detects the fluid temperature to be in a range of the desired fluid temperature, and, if the temperature sensor detects the fluid temperature to be within about 3 degrees of the desired fluid temperature and the control receives the user input, the diverter is configured to switch to the oscillating spray configuration.

13. The showerhead assembly of claim 12, wherein the control panel comprises a user interface configured to receive one or more user inputs from the user during operation of the showerhead.

14. The showerhead assembly of claim 13, wherein a first user input of the one or more user inputs is configured to cause the diverter to switch between a first spray configurations of the plurality of spray configurations to a second spray configuration of the plurality of spray configurations.

15. The showerhead assembly of any claim 12, wherein the control panel comprises a user interface comprising one or more buttons, each button of the one or more buttons corresponding to a spray configuration of the plurality of spray configurations.

16. The showerhead assembly of claim 12, wherein seventh flow rate is between about 1.5 and 3.5 gallons per minute.

17. The showerhead assembly of any claim 12, wherein the fifth flow rate is between about 1 gallon and 2.5 gallons per minute.

18. The showerhead assembly of claim 12, wherein the sixth flow rate is between about 3 and 5 gallons per minute.

19. The showerhead assembly of claim 12, wherein the control system further comprises a presence sensor configured to detect a user presence.

20. The showerhead assembly of claim 19, wherein the plurality of spray configurations further comprise a low spray configuration configured to cause fluid to exit the plurality of fluid outlets at an eighth flow rate, wherein the eighth flow rate is less than the seventh flow rate;
wherein, when the showerhead assembly is in the open position and the presence sensor does not detect the user presence, the diverter is configured to cause the fluid to flow in the low spray configuration.

21. The showerhead assembly of claim 20, wherein the eighth flow rate is less than about 1 gallon per minute.
